(19) United States
(12) Patent Application Publication
(10) Pub. No.: US 2026/0103283 A1
(43) Pub. Date: Apr. 16, 2026

(54) Coanda-Venturi Lift System

(71) Applicant: Jordan Stachura, Sparks, MD (US)

(72) Inventor: Jordan Stachura, Sparks, MD (US)

(21) Appl. No.: 19/318,118

(22) Filed: Sep. 3, 2025

(51) Int. Cl. B64C 39/06; B64C 27/20

(52) U.S. Cl. CPC B64C 39/06; B64C 27/20

(57) ABSTRACT

This system for propulsion comprises a lifting assembly formed by concentric, opposing aerodynamic surfaces defining a narrowing annular flow channel, and an internal flow inducer configured to draw fluid through the channel. The channel's geometry causes fluid to accelerate via the Venturi effect and adhere to the channel surfaces via the Coandă effect, generating lift and propulsion.

### 1. BACKGROUND OF THE INVENTION

### 1.1 Field of the Invention

The invention relates to fluid dynamics and propulsion systems, and more particularly to a ducted fan-powered system for generating lift using the Coandă and Venturi effects. This system is applicable to a variety of vehicle types, including aerial vehicles (such as vertical takeoff aircraft, drones, and flying saucers), aquatic vehicles (including submersibles and surface vessels), and hybrid platforms capable of operating in both air and water.

### 1.2 Description of Prior Art

The use of ducted fans and Coandă-effect-based designs has been extensively explored to improve thrust vectoring, lift efficiency, and aerodynamic control for aeronautical vehicles. However, existing implementations tend to employ geometries that do not fully leverage synergistic aerodynamic effects such as those produced when coupling the Coandă effect with Venturi acceleration through contoured annular flow paths.

For instance, WO 2011/004187 A2 and WO 2009/027742 A1 induce the Coandă effect by passing air over a dome via a fan mounted at the dome's apex. However, both of these systems encounter difficulty with regards to maintaining constant adhesion and radial flow of air across the surface(s) of the dome, which they attempt to remedy using complex and somewhat arbitrary flow-diversion mechanisms. On the other hand, U.S. Pat. No. 6,672,539 B1 employs an annular duct between concentrically-nested structures to generate thrust from an internally-mounted rotary pump. However, the structures of this design, which are described as “generally cylindrical” (for the inner structure), and a “torus shape” (for the outer), are not aerodynamically configured to function as lifting surfaces, which neglects an opportunity to substantially increase the overall power generated by the system.

The prior art as a whole exhibits a tendency toward inelegance, with an excessive reliance on complex moving parts and flow-diversion surfaces, including foils and external control surfaces. There remains a need for a compact and efficient propulsion system that fully leverages the aerodynamic potential of the Coandă effect for lift and propulsion.

### 2. SUMMARY OF THE INVENTION

The present invention comprises a hollowed aerodynamic shroud with openings at its crown and base, and a slightly smaller aerodynamic dome mounted concentrically within it, forming an annular flow channel between the concave interior surface of the outer shroud and the convex upper surface of the inner dome. A fan concealed beneath the inner dome draws a fluid medium (e.g., air or water) through this narrow channel, exploiting a synergy between the Venturi effect and the Coandă effect as the fluid moves at high velocity over the curved surfaces of the channel. This produces lift and directs flow with greater efficiency than can be achieved with existing designs, while also displacing mechanical loads from the moving fan onto the channel's static lifting surfaces, achieving a simple and elegant system not suggested or realized in prior art.

### 3. BRIEF DESCRIPTION OF THE DRAWINGS

The drawings are schematic representations provided for purposes of illustration and description, and are not intended to represent precise scale or proportion.

FIG. 1: Side cross-sectional view of the assembly.

FIG. 2: Perspective illustration of the assembly.

FIG. 3: Diagram showing inertia-based directional control.

FIG. 4: Diagram showing adjustable flow channel geometry.

FIG. 5: Side cross-sectional view of an embodiment with multiple channels subdividing the inner dome.

FIG. 6: Side cross-sectional view of an embodiment with multiple channels defined by additional shrouds.

### 4. DETAILED DESCRIPTION OF THE INVENTION

The invention comprises a propulsion system with an aerodynamically optimized structure that enhances lift and maneuverability through combined use of the Venturi and Coandă effects. The figures depict an exemplary embodiment of this system.

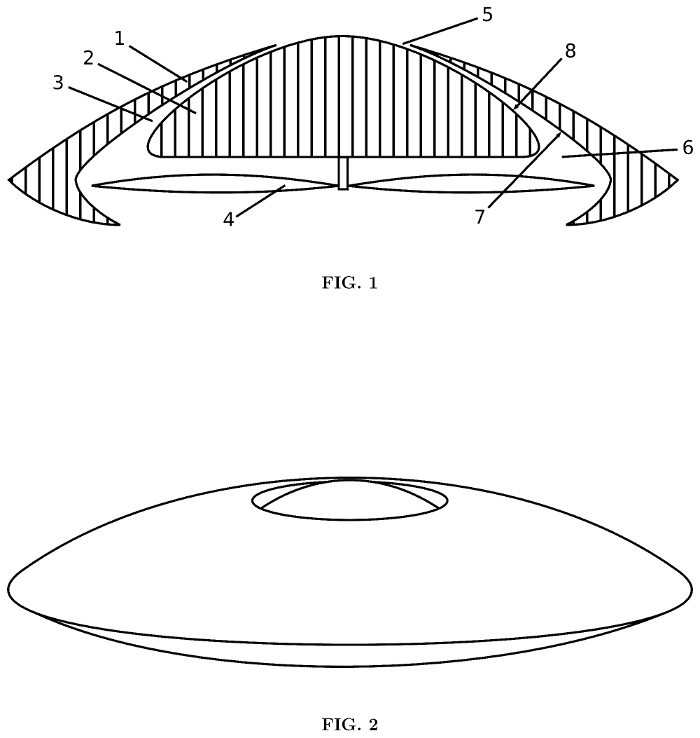

Referring to FIG. 1, the lifting assembly is composed of an outer aerodynamic shroud (1) and an inner aerodynamic dome (2). The outer shroud has an aerodynamic lenticular exterior and a concave interior cavity, forming a shallow toroid shell with a narrow top aperture and a wide base opening. The inner dome, slightly smaller than the cavity defined by the outer shroud, is mounted inside, forming a narrow, annular flow channel (3) between the opposing aerodynamic surfaces.

A fan assembly (4) is mounted concentrically beneath the inner dome's base, oriented to draw the fluid medium toward it through the channel. In the figure, the fan assembly is represented abstractly, since any conventional fan, propeller, or impeller design should suffice for this application. For example, the fan assembly may employ counter-rotation to mitigate torque imbalance. Because the fan is primarily used to induce flow, rather than to generate lift or thrust directly, much of the mechanical stress is distributed to the aerodynamic surfaces of the channel, which generate propulsive forces using principles of fluid dynamics.

The flow channel is narrowest at the top aperture, creating a Venturi throat (5) that maximizes suction at the intake. The widening of the channel at the inner dome's base (6) allows incoming fluid to slow so that it can be efficiently drawn by the fan assembly. The high-speed flow adheres to the concave inner surface (7) of the outer shroud and the convex outer surface (8) of the inner dome via the Coandă effect, resulting in a pressure differential across the channel surfaces that contributes significantly to lift.

### 4.1 Optional Enhancements

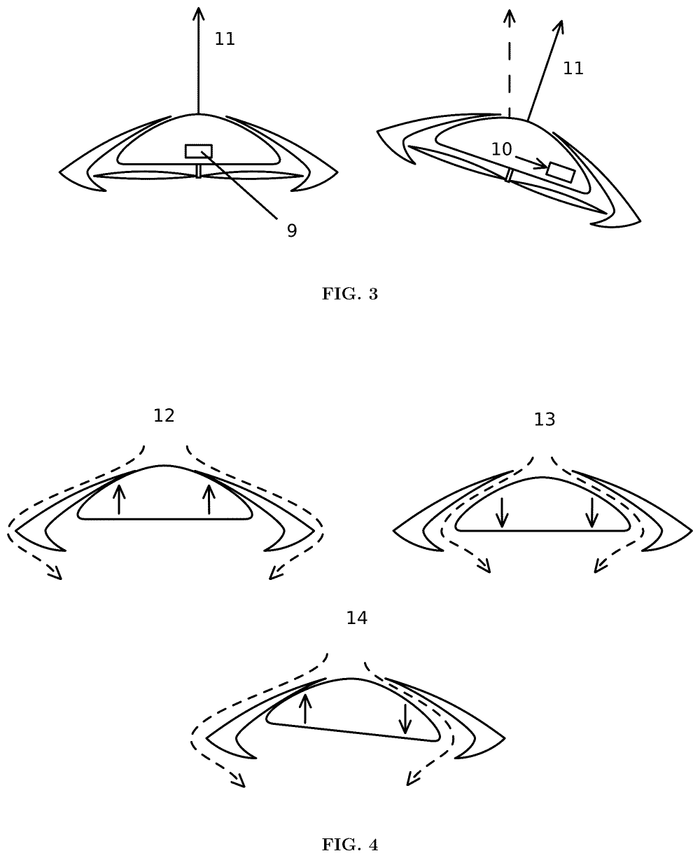

As shown in FIG. 3, to enable control of thrust vectoring and orientation, movable masses or actuators (9) may be positioned within the inner dome. By altering the center of gravity (10), the net vector of lift and thrust (11) can be adjusted without external control surfaces. This approach enhances maneuverability, especially at low and moderate speeds.

Another self-contained control mechanism is shown in FIG. 4. If the inner dome is mounted within the outer shroud using actuators instead of static supports, the separation of the shroud and dome can be dynamically adjusted to change the geometry of the annular channel between them, allowing for restriction (12) or improvement (13) of flow, modifying the lifting properties of the channel. This mechanism can be used to create asymmetries (14) in the channel profile that alter the overall lift vector.

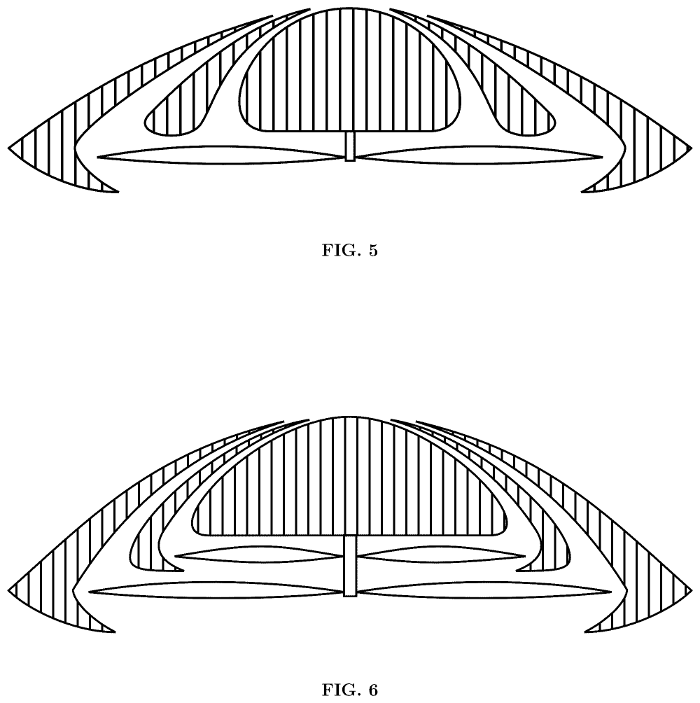

Furthermore, this system is highly scalable. Additional concentric annular channels formed by opposing aerodynamic surfaces can be arranged around the lifting assembly to enhance lift. FIGS. 5 and 6 show embodiments of this system that use multiple channels to further exploit the Coandă and Venturi effects by increasing surface area without increasing volume. This may take the form of additional channels subdividing the inner dome (FIG. 5), or it may manifest as a nested implementation of the system (FIG. 6) with repeated shrouds and additional rotors in the fan assembly.

The system is highly adaptable and can be integrated directly into the structure of a vehicle or drone. In a self-contained implementation, the inner dome may house a pilot or passengers, combining the thrust/lift system with the vehicle structure itself. Its enclosed and compact design reduces mechanical complexity, increases safety, and allows operation in confined underwater or urban spaces.

1. A system for propulsion, comprising:
(a) a lifting assembly formed by concentric, opposing aerodynamic surfaces, defining a narrowing annular flow channel between them;
(b) a flow inducer configured to draw fluid through said channel;
(c) wherein the geometry of the channel causes fluid to accelerate via the Venturi effect and adhere to the surfaces of the channel via the Coandă effect, thereby generating lift in the direction of the central axis.

2. The system of claim 1, wherein the propulsion apparatus comprises:
(a) a hollowed aerodynamic shroud with a concave inner surface and an open top and base;
(b) an inner aerodynamic dome concentrically mounted within the outer shroud, forming a convex outer surface opposing the inner surface of the shroud;
(c)an annular flow channel formed by the separation of the opposing surfaces of the shroud and dome, being wider at the base and narrower at the apex;
(d) a fan assembly beneath the base of the dome, within the shroud, that is configured to draw fluid through the flow channel;
(e) whereby the apparatus generates propulsive forces as described in claim 1.

3. The system of claim 1, wherein the opposing surfaces of the annular channel are of any aerodynamic profile that accelerates flow via the Venturi effect and promotes flow adhesion via the Coandă effect.

4. The system of claim 1, further comprising additional concentric aerodynamic surfaces and annular channels surrounding the lifting assembly, configured to enhance lift using the Coandă and Venturi effects.

5. The apparatus of claim 2, further comprising movable masses or actuators disposed within the inner dome, configured to alter the thrust vector by shifting the center of gravity.

6. The apparatus of claim 2, further comprising actuators configured to adjust the separation of the shroud and dome, thereby modifying the geometry of the annular channel to control flow and lift.

7. The system of claim 1, wherein the system is integrated into a vehicle or drone to provide lift, propulsion, or both.

8. The system of claim 1, wherein the system is configured for aquatic or submerged operation in a fluid medium other than air, or for hybrid operation in air and water.
